(19) United States
(12) Patent Application Publication
(10) Pub. No.: US 2020/0037512 A1
(43) Pub. Date: Feb. 6, 2020

(54) ENVIRONMENT-CONTROLLED MULTI-SPAN STRUCTURED GREENHOUSES

(71) Applicant: Sat Parkash Gupta, Chandigarh (IN)

(72) Inventor: Sat Parkash Gupta, Chandigarh (IN)

(21) Appl. No.: 16/205,841

(22) Filed: Nov. 30, 2018

(30) Foreign Application Priority Data
Aug. 3, 2018 (IN) 201811029265
Nov. 15, 2018 (IN) 201811042923

(51) Int. Cl. A01G 9/24; A01G 9/18; A01G 9/20; A01G 9/14; A01G 7/02; A01G 7/04; F24F 5/00; F24F 11/00

(52) U.S. Cl. CPC A01G 9/246; A01G 9/18; A01G 9/20; F24F 11/0008; A01G 7/02; A01G 7/045; F24F 5/005; A01G 9/1438

(57) ABSTRACT

An environment-controlled multi span structured greenhouse comprising a roof, four sides, a release blower equipped with a heating module in relatively cold weather geographical locations, and equipped with a cooling module in relatively hot weather geographical locations, a capture blower, a release blower, a release manifold, and a capture manifold for low cost of supplementary heating and cooling of the greenhouse air, obviating burning fossil fuels thereby reducing global warming, wherein the external surfaces of the roof and the external surface of at least one side of the greenhouse comprise a light diffusing film on predetermined areas and locations thereof together with a thermal shading film affixed to the surface areas not comprising the light diffusing film, and wherein the greenhouse further comprises a mechanized module for adjusting the height of artificial light source and a module for melting snow

### RELATED APPLICATION

The present application claims priority from Indian Patent Application No. 201811029265 filed on Aug. 3, 2018, and Indian Patent Application No. 201811042923 filed on Nov. 15, 2018.

### FIELD OF INVENTION

The present invention relates to environment-controlled multi-span structured greenhouses comprising low cost supplementary heating and cooling for low cost food production. The present invention also relates to low cost heating of premises such as residential and commercial premises including, for example, but not limited to, offices, malls, multiplexes, hotels, industrial units and the like, while reducing or eliminating the consumption and burning of fossil fuel. The present invention further relates to melting snow on surfaces, including for example, but not limited to, airport runways, railway tracks and roads, in relatively cold weather geographical locations. The present invention still further relates to clearing fog in the environment of a greenhouse in relatively cold weather geographical locations.

### BACKGROUND OF THE INVENTION

In relatively cold weather geographical locations, there is the problem of very high capital and operating costs of supplementary heating greenhouses, which mostly comprises burning very substantial amounts of fossil fuels which co-produces carbon dioxide and other pollutants, most of which increase global warming and some of which are also harmful to plants in the greenhouse.

When a fossil fuel burns, it radiates heat and releases carbon dioxide. Once in the atmosphere, some of that carbon dioxide can linger for thousands of years and trap heat that would otherwise leak into space. As reported by researchers online in “Greenhouse gas-caused warming felt in just months.”, ScienceDaily, 2 Jun. 2015, Carnegie Institution, over the lifetime of released carbon dioxide, the trapped heat exceeds the heat released during combustion by a factor of more than 100,000.

Likewise, in relatively cold weather geographical locations, there is the problem of very high capital and operating costs of heating premises such as residential and commercial premises including, for example, but not limited to, offices, malls, multiplexes, hotels, industrial units and the like, which mostly comprises burning very substantial amounts of fossil fuels to heat, for example, water to 70-80° C. for circulation into the heating radiators.

Similarly, in relatively hot weather geographical locations, there is the problem of very high capital and operating costs of supplementary cooling greenhouses, which comprises using substantial electric energy mostly produced by burning substantial amounts of fossil fuels.

There is also the problem of maintaining the crops in greenhouses free from diseases, pathogens and harmful organisms and pests such as bacteria, fungi, viruses, insects and the like etc.

The intensity or brightness of light is a function of the distance from the light source following an inverse square relationship. There is the problem in greenhouses of adjusting the height of an artificial light source to maintain the artificial light a predetermined distance from the top of the growing plants, which is very labour and operating cost intensive. As such, the greenhouse growers mostly install the artificial light source at a predetermined and fixed distance above the top level of a fully grown plant, the level at which a growing plant would achieve after a long duration such that the plants during their earlier growth stages derive minimal benefit from the artificial light source which leads to reduced productivity.

There is also the problem of melting snow on various surfaces such as, for example, but not limited to, roadways, railway tracks and airport runways. In many instances, snow on airport runways is melted by built-in heating modules in the concrete slabs of the runway mostly using fossil fuel or electric energy which is mostly a product of burning fossil fuels, whereas snow on roadways, railway tracks and the like is removed by earth moving machines which use diesel, a fossil fuel product.

Another problem is mist, a very fine continuous layer of moisture on the interior surfaces of the gutters of the greenhouse and of the film cover of the greenhouse, wherein during cold early morning hours, when temperature decreases and relative humidity saturates, a dense fog is formed in the greenhouse environment which also reduces light transmission into the greenhouse.

Another problem is fog which disrupts road, railway and air traffic causing numerous accidental deaths and wastage of time and fuel because road vehicles such as cars, trucks and busses, railway vehicles such as trains and air traffic such as airplanes are delayed or have to move at very slow speed due to poor visibility.

With respect to air traffic, although airports are mostly equipped with the facility of an instrument landing system (ILS) which is also installed on the airplanes themselves, these systems are without problem. Due to the complexity of ILS localizer and glide slope systems, there are some limitations. Localizer systems are sensitive to obstructions in the signal broadcast area, such as large buildings or hangars. Glide slope systems are also limited by the terrain in front of the glide slope antennas. If terrain is sloping or uneven, reflections can create an uneven glidepath, causing unwanted needle deflections. Additionally, since the ILS signals are pointed in one direction by the positioning of the arrays, glide slope supports only straight-line approaches with a constant angle of descent. Installation of an ILS can be costly because of siting criteria and the complexity of the antenna system. ILS critical areas and ILS sensitive areas are established to avoid hazardous reflections that would affect the radiated signal. The location of these critical areas can prevent aircraft from using certain taxiways leading to delays in take-offs, increased hold times, and increased separation between aircraft.

The ILS technology is only surpassed by the CAT IIIC system, which allows landing in near-zero visibility. CAT IIIC is three to four times more expensive to operate than CAT IIIB and just a handful of airports in the world, including the JFK airport in New York and London's Heathrow, are equipped with this facility. Despite this, flight disruptions are a regular occurrence. One reason for this is that not all pilots are familiar with the system. Not all pilots flying domestic airplanes are trained to land on the CAT IIIB system.

Indian Patent Application No. 201711025454, filed on Jul. 18, 2017, and patent applications claiming priority therefrom, including U.S. patent application Ser. No. 15/844,354, all filed by the same present inventor, relate to an environment-controlled multi-span structured greenhouse comprising a compressor which is used mostly for adjusting the relative humidity of the greenhouse air corresponding to a predetermined relative humidity set point in relatively cold weather geographical locations and for adjusting the temperature of the greenhouse air to a predetermined set point in the relatively hot weather geographical locations.

There is still a further need and scope for overcoming the above-identified problems associated with heating and cooling of greenhouse air and further means for low cost of food production.

### SUMMARY OF THE INVENTION

It is an object of the present invention to overcome the cost associated with heating and cooling air of greenhouses and heating residential and commercial premises including, but not limited to, offices, malls, multiplexes, hotels, industrial units and the like, and/or to provide the consumer with a useful or commercial choice.

It is also an object of the present invention to overcome the cost associated with heating and cooling air of greenhouses and heating residential and commercial premises and eliminating the requirement for, and use of, a compressor.

It is also an object of the present invention to provide a tangible low cost method to reduce and/or eliminate fog related problems, particularly for road, train and air traffic for airplanes landing at and taking off from airports.

In accordance with an aspect of the present invention, there is provided an environment-controlled, multi-span structured greenhouse, in relatively hot weather geographical locations, comprising: a roof, four sides, a capture manifold together with a capture blower for capturing carbon dioxide rich air from above the plants growing the greenhouse during dark hours and for capturing oxygen rich air from the greenhouse during light hours and blowing the captured air into an earth tube heat exchanger for storing and conditioning the captured air, equal to an average thermal constant temperature of the earth tube heat exchanger of the location comprising a first compartment for storing and conditioning to a relatively cooler temperature, the captured carbon dioxide rich air, and a second compartment for storing and conditioning to a relatively cooler temperature, the captured oxygen rich air, wherein a release manifold together with a release blower equipped with a cooling module, for releasing into the greenhouse, during light hours, the stored carbon dioxide rich conditioned cooled air by the cooling module and during dark hours, the stored oxygen rich conditioned and cooled air by the cooling module.

In an embodiment of the present invention, in relatively cold weather geographical locations, hot air is released into the greenhouse at the cultivation level which after heating the plants becomes relatively lower temperature hot air which collects above the plants in the upper portion of the greenhouse, which is captured by the capture blower together with capture manifold, wherein relatively lower temperature hot carbon dioxide rich greenhouse air is stored in the first compartment of the storage facility whereas relatively lower temperature hot oxygen rich greenhouse air is stored in the second compartment of the storage facility.

In another embodiment of the present invention, in relatively hot weather geographical locations, the external surfaces of the greenhouse roof together with the external surface of at least one side of the greenhouse comprise a light diffusing film affixed to predetermined areas and locations thereof based upon the climate pattern of the geographical location and wherein the areas that do not comprise a light diffusing film comprise a thermal shading film of a predetermined thickness for admitting into the greenhouse only a predetermined deficient solar radiation for minimizing needless heat gain, reducing greenhouse air temperature and minimizing supplementary cooling cost while availing the benefits of natural light.

In another embodiment of the present invention, in relatively cold weather geographical locations, the greenhouse comprises a heating module which functions with the release blower for heating the greenhouse air for maintaining the temperature of the greenhouse air at a predetermined set point.

In another embodiment of the present invention, in relatively hot weather geographical locations, the greenhouse comprises a cooling module which functions with the release blower for cooling the greenhouse air for maintaining the temperature of the greenhouse air at a predetermined set point.

In another embodiment of the present invention, the environment-controlled, multi span structured greenhouse further comprises an artificial light source and a mechanized module for adjusting the height of the artificial light source for maintaining a predetermined distance between the artificial light source and a top of a growing plant growing in the greenhouse throughout all growth stages of the growing plant.

In another embodiment of the present invention, in relatively hot weather geographical locations, the greenhouse further comprises an automated water pump and a fogger for injecting fine droplets of water into the outlet pipe of the release blower for maintaining the relative humidity of the greenhouse air at a predetermined set point.

In another embodiment of the present invention, in relatively cold weather geographical locations, the greenhouse air relative humidity is maintained at a point wherein the moisture content of the greenhouse air during heating is squeezed out thus automatically maintaining the relative humidity of the greenhouse air at a point corresponding to the greenhouse air temperature predetermined set point.

In another embodiment of the present invention, the environment-controlled, multi span structured greenhouse further comprises a magnifying camera for capturing images of parts of suspected diseased plants growing in the greenhouse or of pests on plants growing in the greenhouse, wherein the captured images are uploaded onto a computer and compared and matched with reference images of diseased parts of plants and pests stored on the computer wherein a positive match between the uploaded image and the stored image dictates the treatment regimen.

In another embodiment of the present invention, the treatment regimen comprises dose, frequency mode foliar or drench and the matched uploaded and stored images are displayed on the computer screen for printing the prescribed treatment for execution which is automatically stored in a file to trace treatment history of a crop during its life time.

In another embodiment of the present invention, the environment-controlled, multi span structured greenhouse further comprises a storage facility comprising reinforced concrete pipes which together with the inlet and outlet pipes of both the storage compartments are fully insulated from the atmosphere such that the stored relatively lower temperature hot carbon dioxide rich air and the stored relatively lower temperature hot oxygen rich air remains substantially the same temperature as when it was captured without conditioning or cooling, wherein the first compartment of the storage facility for storing captured relatively lower temperature hot carbon dioxide rich greenhouse air and a second compartment of the storage facility for storing captured relatively lower temperature hot oxygen rich greenhouse air, wherein the storage facility is installed outside and adjoining the greenhouse.

In another embodiment of the present invention, in relatively hot weather geographical locations, the greenhouse further comprises: a light diffusing film, in one embodiment, a light diffusing white film, of a predetermined thickness, affixed to the external surface of the greenhouse roof and to the external surface of at least one side of the greenhouse at predetermined areas and locations based upon the climate pattern of the geographical location, wherein the external surfaces that do not have the light diffusing film affixed thereto, have a thermal shading film of a predetermined thickness affixed thereto based upon the climate pattern of the geographical location.

In another embodiment of the present invention, in relatively cold weather geographical locations, the release blower is equipped with a heating module for heating the greenhouse air for maintaining the greenhouse air at a predetermined temperature set point.

In another embodiment of the present invention, in relatively hot weather geographical locations, the release blower is equipped with a cooling module for cooling the greenhouse air for maintaining the greenhouse air temperature at a predetermined temperature set point.

In another embodiment of the present invention, in relatively hot weather geographical locations, the relative humidity of the greenhouse air is maintained at a predetermined set point by injecting, using a small automated pump, fine droplets of water from a fogger manifold into the outlet pipe of the release blower at predetermined center locations along the length of the outlet pipe.

In another embodiment of the present invention, in relatively cold weather geographical locations, the greenhouse air is heated using a release blower together with a heating module which lowers the moisture content and maintains the relative humidity of the greenhouse air corresponding to a predetermined temperature set point of the greenhouse air.

In another embodiment of the present invention, the greenhouse further comprises a module, in one embodiment a mechanized module, for adjusting the height of the artificial light source for maintaining a predetermined distance between the artificial light source and the top of the growing plant. Accordingly, this aspect satisfies the need for raising the height of the artificial light source to maintain a predetermined distance from the top of the growing plants, and in one embodiment uses a mechanized module for this purpose.

In another embodiment of the present invention, the greenhouse further comprises at least one camera, in an embodiment, a magnifying camera, for capturing images of suspected diseased plants and parts thereof growing in the greenhouse or of pests, such as insects, in, on or around plants growing in the greenhouse, wherein the captured images are uploaded onto a computer and compared and matched with reference images of diseased plants or parts thereof and of plant pests stored on the computer wherein a positive match between the uploaded image and the stored image dictates the type of treatment and the treatment regimen. In an embodiment of the present invention, the parts of the suspected diseased plants may be roots, stems, leaves, buds, flowers, fruits, etc. In another embodiment of the present invention, a crop patrolling officer of the greenhouse may be equipped with the camera or, for example, a mobile phone, for capturing images, during patrolling the greenhouse, of suspected diseased plants or parts thereof and of plant pests, which images are uploaded onto a computer.

In accordance with another aspect of the present invention, there is provided a system and/or method for melting snow on a surface, the system and/or method comprising at least two blowers, each blower equipped with a heating module, each blower mounted on a motorized trolley wherein at least one motorized trolley is located staggered on each of the two sides of the surface for producing hot air of a predetermined temperature for melting snow on the surface. In another embodiment of the present invention, based upon the length of the surface, there are a plurality of blowers located staggered at predetermined distances between each other. In another aspect of the present invention, the surface is the surface of an airport runway, a roadway, a railway track and the like.

In another embodiment of the present invention, an electric heating module of a predetermined temperature range is installed in a blower for all heating needs including heating small furnaces of medium and small-scale industries. Accordingly, this module saves substantial fossil fuel.

In another embodiment of the present invention, in relatively cold weather geographical locations, a blower together with an electric heating module is provided which is used for heating the local environment of a location occupied by persons for maintaining the temperature of that location at a predetermined temperature set point.

In another embodiment of the present invention, in relatively hot weather geographical locations, a blower together with a cooling module is provided which is used for cooling the local environment of a location occupied by persons for maintaining that location at a predetermined temperature set point.

In accordance with another aspect of the present invention, there is provided an environment-controlled, multi-span structured greenhouse comprising: a roof and four sides wherein in a relatively hot weather geographical location, the external surfaces of the roof together with the external surface of at least one side of the greenhouse comprise a light diffusing film, in one embodiment, a light diffusing white film, of a predetermined thickness, affixed to predetermined areas and locations thereof based upon the climate pattern of the geographical location and wherein the external surfaces that do not have a light diffusing film affixed thereto comprise a thermal shading film of a predetermined thickness affixed thereto, for admitting into the greenhouse only a predetermined deficient solar radiation for minimizing needless heat gain, reducing greenhouse air temperature and minimizing supplementary cooling cost while availing the benefits of natural light.

In another embodiment of the present invention, the external surface of at least one side of the greenhouse comprises both a light diffusing film, in one embodiment, a light diffusing white film, of a predetermined thickness affixed to predetermined areas and locations thereof together with a thermal shading film of a predetermined thickness affixed to predetermined areas and locations thereof and the sides of the greenhouse which do not have the light diffusing film together with the thermal shading film affixed thereto, comprise only a thermal shading film of a predetermined thickness affixed to predetermined areas and locations thereof.

In accordance with another aspect of the present invention, there is provided a tangible solution to the problem of the very high cost of heating greenhouses and residential and commercial premises including, but not limited to, offices, malls, multiplexes, hotels, industrial units and the like, which are located in relatively cold weather geographical locations, wherein these premises would otherwise be heated by burning very substantial amounts of fossil fuels to heat water to 60-80° C. for circulation into the heating radiators.

In accordance with another aspect of the present invention, there is provided a greenhouse, wherein in relatively cold weather geographical locations, the greenhouse comprises a release blower equipped with a heating module for heating the greenhouse air for maintaining the temperature of the greenhouse air at a predetermined set point and wherein, in relatively hot weather geographical locations, the greenhouse comprises a release blower equipped with a cooling module for cooling the greenhouse air for maintaining the temperature of the greenhouse air at a predetermined set point.

In accordance with another aspect of the present invention, there is provided a tangible solution to the problem of the very high cost of supplementary cooling of a greenhouse in relatively hot weather geographical locations which would otherwise be cooled using electric energy produced by burning of fossil fuels.

In accordance with another aspect of the present invention, there is provided a mechanized module for adjusting the height of an artificial light source in a greenhouse for maintaining a predetermined distance between the artificial light source and the top of a plant growing in the greenhouse throughout all the growth stages of the growing plant.

In another embodiment of the present invention, the greenhouse further comprises at least one camera, in one embodiment, a magnifying camera, for capturing images of a plant growing in the greenhouse, in one embodiment, a suspected diseased plant, or part thereof, for example, but not limited to, roots, stems, leaves, buds, flowers and the like, or of pests, in one embodiment, insects, in, on or around the plant, wherein the captured images are uploaded onto a computer wherein reference images of diseased plants or parts of plants and pests are already stored for matching with the uploaded images wherein the recommended treatment, including the treatment regimen, including for example, the dose and frequency of the treatment, such as for example, but not limited to, the dose and frequency of application of chemicals to the plant or parts thereof, such as pesticides, herbicides, fungicides or the like, the dose and frequency of application of fertilizer or the like to the plant or parts thereof, the dose and frequency of application of water to the plant or parts thereof, etc., wherein the recommended treatment and treatment regimen is displayed on the computer together with the uploaded image and the matched image for printing the recommended treatment for execution which is automatically stored in a file to trace treatment history of a crop of plants grown in the greenhouse during its life time. In an embodiment of the present invention, a greenhouse crop patrolling officer may be equipped with the camera when patrolling the greenhouse.

In another embodiment of the present invention, in relatively cold weather geographical locations, hot air is released into the greenhouse at the level of cultivation of the plants growing in the greenhouse, which hot air, after heating the plants cools, the temperature of which becomes lower relative to the temperature of the hot air released into the greenhouse, this relatively lower temperature hot air collects above the plants in the upper portion of the greenhouse and is captured by the capture blower together with capture manifold. Captured relatively lower temperature hot carbon dioxide rich greenhouse air is stored into a first compartment of a storage facility, whereas the captured relatively lower temperature hot oxygen rich greenhouse air is stored into a second compartment of the storage facility.

The features described with respect to one aspect and/or embodiment of the present invention also apply, where applicable, to all other aspects and/or embodiments of the present invention. Furthermore, different combinations of described features are herein described and claimed even when not expressly stated.

### BRIEF DESCRIPTION OF THE DRAWINGS

In order that the present invention can be more readily understood, reference will now be made to the accompanying drawings wherein:

FIG. 1 illustrates an inverse square relationship between the intensity of the light source and the distance from the light source.

FIG. 2 illustrates a mechanized module of the present invention for adjusting the height of the artificial light source to maintain a predetermined distance from the growing plant in various growing stages. Reference Numerals in FIG. 2:
100—Mild steel pipe;
110—Upper surface of the mild steel pipe;
120—Bottom surface of the mild steel pipe;
130—Bottom of adjoining truss for welding ball bearing with mild steel pipe;
140—Ball bearing with mounting end plugged;
150—Ball bearing with small hole in the plugged end for running electric main wire;
160—Mild steel strip on ball bearing for welding with the bottom end of the adjoining truss of the greenhouse;
170—Connections to the artificial lighting source;
180—Electric wire running full lengths of growing media beds; and
190—Handle.
FIG. 3 illustrates the components of an environment-controlled, multi-span structured greenhouse in accordance with an embodiment of the present invention. Reference Numerals in FIG. 3:
300—Capture manifold;
310—From capture blower;
380—From BT hot air tank;
390—From BT CO₂ tank;
400—Release manifold;
410—Release blower;
420—Heating module for relatively cold geographical location;
430—Cooling module for relatively hot geographical location;
440—Individual release pipes;
500—Earth tube heat exchanger;
520—Compartment storing oxygen rich greenhouse air; and
530—Compartment storing carbon dioxide rich greenhouse air.

FIG. 4 illustrates the components of the storage facility for storing captured relatively lower temperature hot carbon dioxide rich air and captured relatively lower temperature hot oxygen rich greenhouse air. Reference Numerals in FIG. 4:
600—First compartment of the storage facility comprising a reinforced concrete pipe fully insulated from the atmosphere for storing captured relatively lower temperature hot carbon dioxide rich greenhouse air captured by capture blower 310 together with capture manifold 300;
610—Right-hand end blocked and maintained air tight;
620—Left-hand end blocked and maintained air tight;
630—Inlet comprising a PVC pipe of a predetermined diameter for introducing captured relatively lower temperature hot carbon dioxide rich greenhouse air captured by capture blower 310 together with capture manifold 300 into first compartment 600;
640—Outlet comprising a PVC pipe of a predetermined diameter for releasing stored relatively lower temperature hot carbon dioxide rich air from the first compartment 600 back into the greenhouse via the release blower together with the release manifold;
700—Second compartment of the storage facility comprising a reinforced concrete pipe fully insulated from the atmosphere for storing captured relatively lower temperature hot oxygen rich greenhouse air captured by capture blower 310 together with capture manifold 300;
710—Right-hand end blocked and maintained air tight;
720—Left-hand end blocked and maintained air tight;
730—Inlet comprising a PVC pipe of a predetermined diameter for introducing captured relatively lower temperature hot oxygen rich greenhouse air captured by capture blower 310 together with capture manifold 300 into second compartment 700; and
740—Outlet comprising a PVC pipe of a predetermined diameter for releasing stored relatively lower temperature hot oxygen rich air from the second compartment 700 back into the greenhouse via the release blower together with the release manifold.

### DETAILED DESCRIPTION OF THE PREFERRED EMBODIMENTS

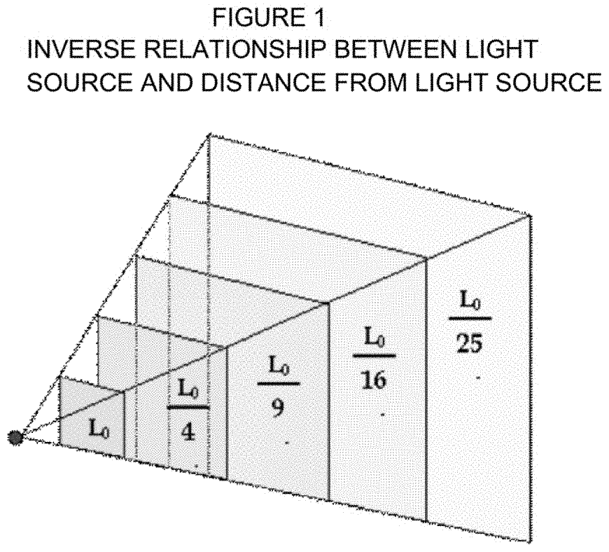

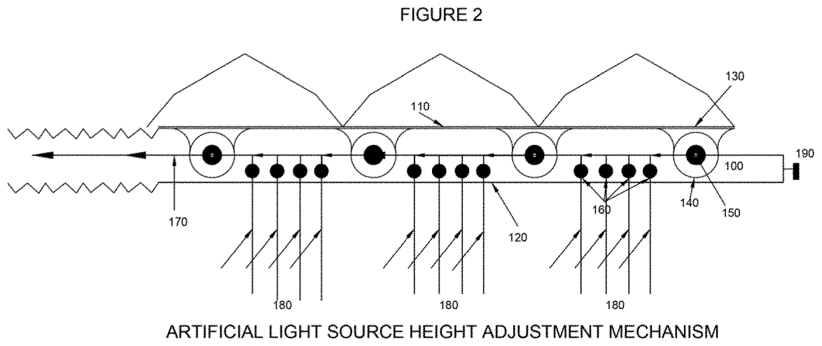

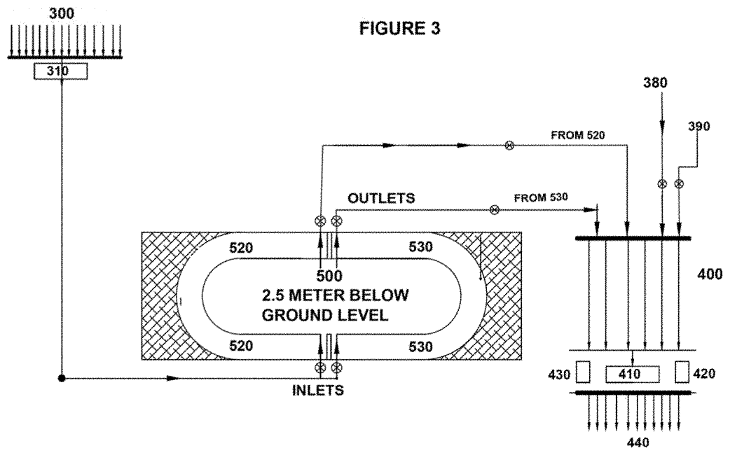

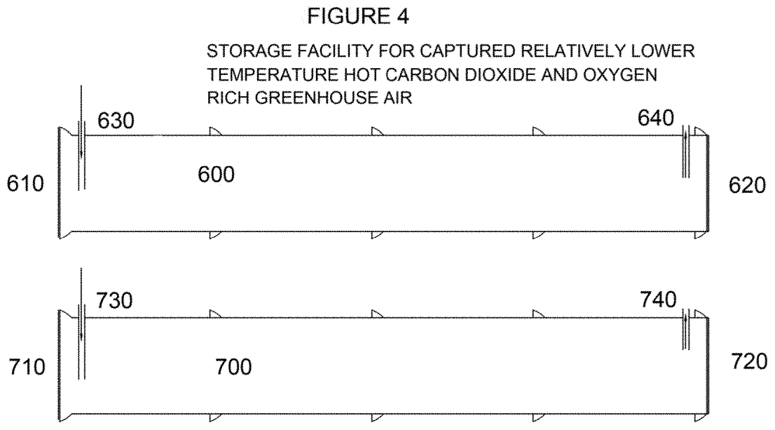

The intensity or brightness of light as a function of the distance from the light source follows an inverse square relationship. This relationship is illustrated by FIG. 1, which shows the apparent brightness of a source with luminosity Lo at distances r, 2r, 3r, etc. As the distance increases, the light spreads out over a larger surface and the surface brightness decreases in accordance with a “one over r squared” relationship. The decrease goes as r squared because the area over which the light is spread is proportional to the distance squared.

Turning to FIG. 2, the mechanized module for adjusting the height of the artificial light source comprises a mild steel pipe 100 having an upper surface 110 and a bottom surface 120 and ball bearings 150 mounted on the mild steel pipe 100 between the upper surface 110 and the bottom surface 120. The mild steel pipe 100 with ball bearings 140 is welded to the bottom 130 of the adjoining truss of the greenhouse. The mounting end of the ball bearings 140 are plugged and the plugged mounting end has a small hole 150 for running the main electrical wire. Ball bearings 140 have a mild steel strip 160 for welding with the bottom end of the adjoining truss of the greenhouse. The mechanized module further comprises connections 170 to electrical wires 180 comprising the artificial lighting sources located at the free ends thereof and running the full lengths of the growing media beds. In operation, when the artificial lighting sources are to be raised up and away from the tops of the plants growing in the media beds of the greenhouse, the mild steel pipe 100 is rotated in one direction, for example, in the clockwise direction, using, for example, the handle 190, and the electrical wires 180 are spooled onto, and wrap around, the mild steel pipe 100, drawing the artificial lighting sources located at the free ends of the electrical wires 180, upwards and away from the tops of the plants growing in the media beds. When the artificial lighting sources are to be lowered down and towards the tops of the plants growing in the media beds of the greenhouse, the mild steel pipe 100 is rotated in the opposite direction, for example, in the counter clockwise direction, using, for example, the handle 190, and the electrical wires 180 are unspooled from, and unwrapped from around, the mild steel pipe 100, lowering the artificial lighting sources located at the free ends of the electrical wires 180, downwards and towards the tops of the plants growing in the media beds. In operation, the handle 190 can be manually operated via by a human operator, to rotate the mild steel pipe 100 or the handle 190 can be automatically operated, via an automated mechanism, to rotate the mild steel pipe 100.

Turning to FIG. 3, in relatively hot weather geographical locations, during dark hours, relatively hot carbon dioxide rich greenhouse air, and during light hours, relatively hot oxygen rich greenhouse air, is captured by the capture manifold 300 together with the capture blower 310 and is blown through inlets into the earth tube heat exchanger 500, in this embodiment, located approximately 2.5 meters below ground level, where the captured relatively hot carbon dioxide rich air is stored in compartment 520 of the earth tube heat exchanger 500 and the captured relatively hot oxygen rich air is stored in compartment 530 of the earth tube heat exchanger 500. While being stored in compartments 520 and 530, the temperature of the stored relatively hot carbon dioxide rich air and the stored relatively hot oxygen rich air, respectively, is lowered (cooled) or “conditioned” to be substantially equal to the temperature of the earth tube heat exchanger 500. The stored carbon dioxide rich conditioned air from compartment 520 and the stored oxygen rich conditioned air from compartment 530 exits the earth tube heat exchanger 500 and is captured by the release manifold 400 together with the release blower 410 and if required, the temperature thereof is further lowered (cooled) to a predetermined temperature set point by the cooling module 430 and is released back into the greenhouse via individual release pipes 440.

In relatively cold weather geographical locations, during dark hours, relatively cool carbon dioxide rich greenhouse air, and during light hours, relatively cool oxygen rich greenhouse air, is captured by the capture manifold 300 together with the capture blower 310 and is blown through inlets into the earth tube heat exchanger 500, in this embodiment, located approximately 2.5 meters below ground level, where the captured relatively cool carbon dioxide rich air is stored in compartment 520 and the captured relatively cool oxygen rich air is stored in compartment 530. While being stored in compartments 520 and 530, the temperature of the stored relatively cool carbon dioxide rich air and the stored relatively cool oxygen rich air, respectively, is raised (heated) or “conditioned” to be substantially equal to the temperature of the earth tube heat exchanger 500. The stored carbon dioxide rich conditioned air from compartment 520 and the stored oxygen rich conditioned air from compartment 530 exits the earth tube heat exchanger 500 and is captured by the release manifold 400 together with the release blower 410 and if required, the temperature thereof is further raised (heated) to a predetermined temperature set point by the heating module 420 and is released back into the greenhouse via individual release pipes 440.

Turning to FIG. 4, in relatively cold weather geographical locations, during dark hours, captured relatively lower temperature hot carbon dioxide rich greenhouse air is stored in the first compartment 600 of the storage facility and during light hours, captured relatively lower temperature hot oxygen rich greenhouse air is stored into the second compartment 700 of the storage facility. First and second air storage compartments 600 and 700 comprise reinforced concrete pipes having inlets 630/730 and outlets 640/740, wherein the pipes are fully insulated from the atmosphere. The release blower 410 together with release manifold 400 releases into the greenhouse at the level of cultivation of the plants growing in the greenhouse, the stored relatively lower temperature hot carbon dioxide rich air from the first compartment 600 during light hours and the stored relatively lower temperature hot oxygen rich air from the second compartment 700 during dark hours.

In accordance with an aspect of the present invention, there is provided an environment-controlled, multi-span structured greenhouse comprising: a capture manifold and a capture blower for capturing, from the greenhouse, carbon dioxide rich air during dark hours and oxygen rich air during light hours, and for blowing the captured air into an earth tube heat exchanger, the earth tube heat exchanger comprising a first compartment/chamber for storing the captured carbon dioxide rich air and a second compartment/chamber for storing the captured oxygen rich air, the earth tube heat exchanger for conditioning the stored air by increasing or decreasing the temperature of the stored air to substantially equal to the average thermal constant temperature of the earth tube heat exchanger, a release manifold and a release blower for releasing the stored carbon dioxide rich conditioned air into the greenhouse at the level of cultivation of the plants growing in the greenhouse during light hours and the oxygen rich conditioned air from the earth tube heat exchanger during dark hours.

The earth tube heat exchanger is an underground heat exchanger that can capture heat from and/or dissipate heat to the ground and uses the earth's near constant subterranean temperature to warm or cool the air captured from the greenhouse for heat recovery ventilation. The earth tube heat exchanger is known by several other names, including, but not limited to: ground-coupled heat exchangers, earth cooling tubes, earth warming tubes, earth-air heat exchangers, air-to-soil heat exchangers, earth channels, earth canals, earth-air tunnel systems, ground tube heat exchangers, hypocausts, subsoil heat exchangers, thermal labyrinths, underground air pipes, and others.

In an embodiment of the present invention, the greenhouse, in relatively hot weather geographical locations, comprises a light diffusing film, in one embodiment a light diffusing white film, of a predetermined thickness affixed to the external surface of the greenhouse roof and the external surface of at least one side of the greenhouse at predetermined areas and at predetermined locations based upon the climate pattern of the geographical location. The areas not comprising the light diffusing film comprise a thermal shading film of a predetermined thickness such that only a predetermined deficient solar radiation is admitted into the greenhouse for reducing needless heat gain, reducing the greenhouse air temperature and minimizing the greenhouse supplementary cooling cost while availing the benefits of natural light.

In an another embodiment of the present invention, there is provided an environment-controlled, multi-span structured greenhouse comprising: a capture manifold, a capture blower, a release manifold, a release blower, a heating module in relatively cold weather geographical locations and a cooling module in relatively hot weather geographical locations, wherein heating module and cooling module functions with the release blower, an artificial light source, a mechanized module for adjusting the height of the artificial light source and a module for maintaining the greenhouse crop free from diseases, from organisms such as fungi, bacteria, pathogens, viruses and from harmful pests such as insects.

In another embodiment of the present invention, in relatively cold weather geographical locations, the greenhouse comprises a release blower equipped with a heating module for heating the greenhouse air for maintaining the greenhouse air temperature at a predetermined temperature set point. In this embodiment, the release blower together with the release manifold and the heating module releases hot air into the greenhouse at the level of cultivation for greenhouse supplementary heating. During supplementary heating of the greenhouse, the hot air released into the greenhouse at the level of cultivation rises and begins to cool somewhat thus becoming lower temperature hot greenhouse air relative to the temperature of the hot air released at the level of cultivation. This relatively lower temperature hot greenhouse air collects above the plants growing in the greenhouse in the upper portion of the greenhouse, including the upper portion of the roof. The relatively lower temperature hot greenhouse air is then captured by the capture blower together with the capture manifold and the captured relatively lower temperature hot air is stored into the earth tube heat exchanger where it is conditioned to cooler temperature air relative to the captured relatively lower temperature hot air.

In another embodiment of the present invention, in relatively cold weather geographical locations, hot air is released into the greenhouse at the cultivation level of the plants growing in the greenhouse, which released hot air, after heating the plants, cools and becomes a relatively lower temperature than the hot air that was released into the greenhouse, which relatively lower temperature hot air collects above the plants in the upper portion of the greenhouse and is captured by the capture blower together with capture manifold. Captured relatively lower temperature hot carbon dioxide rich greenhouse air is stored in the first compartment 600 of the storage facility whereas captured relatively lower temperature hot oxygen rich greenhouse air is stored in the second compartment 700 of the storage facility.

Both first 600 and second 700 compartment of the storage facility are located just outside and adjoining the greenhouse and together with all inlets 630/730 and outlets 640 and 740, are fully insulated from the atmosphere so that the temperature of the stored air does not decrease. The release blower inlet captures stored relatively lower temperature hot carbon dioxide rich air during light hours from the first compartment 600 and stored relatively lower temperature hot oxygen rich air during dark hours from the second compartment 700, which air is heated to the predetermined temperature by the heating module in the inlet of the release blower. The release blower together with release manifold releases into the greenhouse at cultivation level, carbon dioxide rich hot air during light hours and oxygen rich hot air during dark hours.

In another embodiment of the present invention, in relatively hot weather geographical locations, the greenhouse comprises a release blower equipped with a cooling module for cooling the greenhouse air for maintaining the greenhouse air temperature at a predetermined temperature set point.

In another embodiment of the present invention, in relatively hot weather geographical locations, the relative humidity of the greenhouse air is maintained at a predetermined set point by injecting fine droplets of water from a fogger manifold into the outlet pipe of the release blower using an automated small water pump.

In another embodiment of the present invention, in relatively cold weather geographical locations, the relative humidity of the greenhouse air is automatically adjusted during heating the greenhouse air to a predetermined temperature point which removes the moisture from the cold air, which removed moisture settles at the bottom of the outlet pipe of the release blower which outlet pipe is provided with a predetermined slope to drain off the moisture at a predetermined location.

In another embodiment of the present invention, the greenhouse comprises an artificial light source and a mechanized module for adjusting the height of the artificial light source to maintain a predetermined distance between the artificial light source and the top of the growing plants, wherein the module comprises a steel pipe comprising ball bearings, for example, set at 5 meters centers, with the mounting end of the ball bearings plugged and with a small hole contained therein for running an electric main wire together with about two thirds of the circumference of the ball bearing comprising a mild steel strip for welding onto the bottom of an adjoining truss of the greenhouse wherein main electric wires run on the upper surface of the pipe comprising connections for all of the artificial lighting in respective rows of growing media bags or beds.

In another embodiment of the present invention, the greenhouse is further equipped with at least one camera, in one embodiment, a magnifying camera, for capturing images of abnormal roots, stems, leaves, buds and fruits of suspected diseased plants and of pests such as insects, on, in or around the plants. The images are uploaded onto a computer wherein reference images of all kinds of abnormalities of diseased plants' roots, stems leaves, buds, fruits etc. and all kinds of pests, such as insects, are already stored for matching the uploaded images with the stored images wherein the type of treatment and treatment regime, including the remedy, dose and frequency of dose, including fertilizer and water, together with the uploaded image and the matching stored image are displayed. The treatment and treatment regimen is automatically stored into a file and may be printed to trace the treatment history of the greenhouse crop over its lifetime. In another embodiment of the present invention, a greenhouse crop patrolling officer may be equipped with the camera for capturing the images during patrolling the greenhouse.

In another embodiment of the present invention, a system and/or method is disclosed for melting snow on a surface, including airport runways, railway tracks, roadways, and the like, wherein the system and/or method comprises using two blowers each with a heating module each mounted on a motorized trolley, each one on staggered locations on the two sides of the surface for producing hot air of a predetermined temperature for melting snow on the surface.

In another embodiment of the present invention, there is provided an electric heating module of a predetermined temperature range installed in the blower for all heating needs including heating of small furnaces in medium and small scale industries thereby saving substantial fossil fuel.

In another embodiment of the present invention, in relatively cold weather geographical locations, a blower together with a heating module is provided for heating the local environment of a location occupied by people for maintaining that location at a predetermined temperature set point.

In another embodiment of the present invention, in relatively hot weather geographical locations, a blower together with a cooling module is provided for cooling the local environment of a location occupied by people for maintaining that location at a predetermined temperature set point.

In another embodiment of the present invention, in relatively hot weather geographical locations, the capture blower together with capture manifold captures relatively warmer carbon dioxide rich greenhouse air during dark hours and relatively warmer oxygen rich greenhouse air during light hours from above the plants in the greenhouse, which captured air is stored into the respective first and second compartments of the earth tube heat exchanger which conditions the relatively warmer stored air to relatively cooler air.

In another embodiment of the present invention, in relatively hot weather geographical locations, the release blower, equipped with a cooling module, releases relatively cooler carbon dioxide rich air during light hours and relatively cooler oxygen rich air during dark hours into the greenhouse at cultivation level.

Conditioning of the captured relatively lower temperature hot air to cooler temperature air (relative to the captured relatively lower temperature hot air) by the earth tube heat exchanger may, in some cases, lead to additional heating costs when this cooler temperature air must be re-heated by the heating module to provide greenhouse supplementary heating. As such, it is another object of the present invention to overcome the afore-mentioned potential problem. Thus, in accordance with another aspect of the present invention, there is provided a storage facility comprising a first compartment for storing the captured relatively lower temperature hot carbon dioxide rich greenhouse air and a second compartment for storing the captured relatively lower temperature hot oxygen rich greenhouse air, wherein each of the first and second compartments are insulated from the exterior temperature of the facility such that the stored relatively lower temperature hot carbon dioxide rich air and the stored relatively lower temperature hot oxygen rich air remains substantially the same temperature as when it was captured without conditioning or cooling. Maintaining the relatively lower temperature hot carbon dioxide rich air and the relatively lower temperature hot oxygen rich air in the storage facility at substantially the same temperature as when it was captured without conditioning or cooling results in a minimal differential heating of the stored air before being released back in the greenhouse leading to considerable savings in heating cost and reducing the burning of fossil fuels. In an embodiment of the present invention, each of the first and second compartments are concrete pipes. In another embodiment of the present invention, the concrete pipes are large diameter, reinforced concrete pipes. In an embodiment of the present invention, the storage facility can be installed in a space outside of the greenhouse, preferably adjoining greenhouse. In another embodiment of the present invention, is independent of the earth tube heat exchanger.

As discussed above, there is the problem of fog developing in the greenhouse environment during cold early morning hours when temperature decreases and relative humidity saturates dense fog on the interior surfaces of the greenhouse which reduces light transmission into greenhouse. In an embodiment of the present invention, the release blower, together with the heating module, clears the fog from the interior surfaces of the greenhouse sides and roof by releasing hot air into the greenhouse which increases the relative temperature of the greenhouse air and reduces the relative humidity of the greenhouse air and, in turn, reduces the fog that has accumulated on the interior surfaces of the greenhouse sides and roof.

As also discussed above, there is the problem of fog developing on roadways, railway tracks and in the proximity of airport runways. In an embodiment of the present invention, there is provided a compressor or release blower together with a heating module to heat the released air to a predetermined temperature to evaporate the fog from roadways, railway tracks and in the proximity of airport runways.

In an embodiment of the present invention, there is provided two compressors or two release blowers, each equipped with a heating module installed on the exterior of an airplane (that may already have the facility of ILS) at suitable locations wherein the heated air released from the compressor or blowers evaporates and reduces or eliminates fog that develops around the airplane during its flight and/or reduces or eliminates the fog around the airplane during its flight through fog or clouds. This embodiment assists pilots during the airplane's downward journey in approaching the runway of an airport wherein the airplane mostly has to pass through cloud cover and during this period, the pilot may not be able to see the runway and the landing lights clearly. This embodiment can also be employed to clear fog from airport runways.

In another embodiment of the present invention, there is provided a compressor or a release blower of a predetermined pressure, together with a heating module of a predetermined temperature, installed on both exterior sides of a railway engine at a predetermined location. In this embodiment, as the train moves along the track, hot air generated by the heating module with compressor or a blower clears any fog from railway track so that the train can move as fast through the fog as during clear day light hours with a clear view of the upcoming track. Similar embodiments are contemplated for road vehicles including cars, trucks, including heavy trucks, busses and the like which embodiments will allow these vehicles to move through fog as fast as during the clear day light hours reducing or eliminating accidents due to fog.

Throughout the description and claims of this specification the word “comprise” and variations of that word such as “comprises” and “comprising”, are not intended to exclude other additives, components, integers or steps.

The above description is to be to in no way limit the scope of the present invention which is amendable to various modifications and improvements within the scope of the present invention which will be evident to those skilled in the art. Furthermore, the present invention is not restricted to greenhouse applications only. Although certain embodiments have been described those of skill in the art will appreciate that variations and modifications may be made without departing from the scope thereof as defined by the appended claims.

1. An environment-controlled, multi-span structured greenhouse, in relatively hot weather geographical locations, comprising:
a roof;
four sides;
a capture manifold together with a capture blower for capturing carbon dioxide rich air from above one or more plants growing in the greenhouse during dark hours and for capturing oxygen rich air from the greenhouse during light hours and blowing captured air into an earth tube heat exchanger for storing and conditioning the captured air, wherein a temperature of the captured air is equal to an average thermal constant temperature of the earth tube heat exchanger of the geographical location;
a magnifying camera for capturing images of parts of suspected diseased plants growing in the greenhouse or for capturing images of pests on plants growing in the greenhouse, wherein the captured images are uploaded onto a computer and compared and matches with reference images of diseased parts of plants and pests stored on the computer, wherein a positive match between the uploaded image and the stores image dictates a treatment regimen;
wherein the earth tube heat exchanger comprises:
a first compartment comprising a first reinforced and fully insulated concrete pipe for storing and conditioning captured carbon dioxide rich air to a relatively cooler temperature, the first compartment having an inlet pipe and an outlet pipe; and
a second compartment comprising a second reinforced and fully insulated concrete pipe for storing and conditioning captured oxygen rich air to a relatively cooler temperature, the second compartment having an inlet pipe and an outlet pipe; and
wherein a release manifold together with a release blower equipped with a cooling module is for releasing the stored and conditioned carbon dioxide rich air during light hours and the stored and conditioned oxygen rich air during dark hours into the greenhouse through a plurality of individual release pipes.

2. The environment-controlled, multi-span structured greenhouse of claim 1, wherein in relatively cold weather geographical locations, hot air is released into the greenhouse at a cultivation level, wherein, after heating the plants, a temperature of the hot air is reduced and collects above the plants in an upper portion of the greenhouse, wherein the reduced temperature hot air is captured by the capture blower together with capture manifold, wherein relatively lower temperature hot carbon dioxide rich air is stored in the first compartment whereas relatively lower temperature hot oxygen rich air is stored in the second compartment.

3. The environment-controlled, multi-span structured greenhouse of claim 1, wherein in relatively hot weather geographical locations, external surfaces of the greenhouse roof together with an external surface of at least one side of the greenhouse comprise a light diffusing film affixed to predetermined areas and locations thereof based upon a climate pattern of the geographical location and wherein the predetermined areas that do not comprise the light diffusing film, comprise a thermal shading film of a predetermined thickness for admitting into the greenhouse only a predetermined deficient solar radiation for minimizing needless heat gain, reducing greenhouse air temperature and minimizing supplementary cooling cost while availing the benefits of natural light.

4. The environment-controlled, multi span structured greenhouse of claim 1, wherein in relatively cold weather geographical locations, the greenhouse further comprises a heating module which functions with the release blower for heating greenhouse air and for maintaining a temperature of the greenhouse air at a predetermined set point.

5. The environment-controlled, multi span structured greenhouse of claim 1, wherein, in relatively hot weather geographical locations, the cooling module functions with the release blower for cooling greenhouse air and for maintaining a temperature of the greenhouse air at a predetermined set point.

6. The environment-controlled, multi span structured greenhouse of claim 1, further comprising an artificial light source and a mechanized module for adjusting the height of the artificial light source and for maintaining a predetermined distance between the artificial light source and a top of a growing plant in the greenhouse throughout all growth stages of the growing plant.

7. The environment-controlled, multi span structured greenhouse of claim 1, wherein in relatively hot weather geographical locations, the greenhouse further comprises an automated water pump and a fogger for injecting fine droplets of water into an outlet pipe of the release blower and for maintaining a relative humidity of a greenhouse air at a predetermined set point.

8. The environment-controlled, multi span structured greenhouse of claim 1, wherein, in relatively cold weather geographical locations, a greenhouse air relative humidity is maintained at a point wherein the moisture content of a greenhouse air during heating is squeezed out thus automatically maintaining the relative humidity of the greenhouse air at a point corresponding to a greenhouse air temperature predetermined set point.

9. (canceled)

10. The environment-controlled, multi span structured greenhouse of claim 1, wherein the treatment regimen comprises dose, frequency mode foliar or drench and the matched uploaded and stored images are displayed on the computer screen for printing a prescribed treatment for execution which is automatically stored in a file to trace treatment history of a crop during its life time.

11. The environment-controlled, multi span structured greenhouse of claim 1, wherein the first and second compartments comprise reinforced concrete pipes having inlet and outlet pipes that are fully insulated from the atmosphere such that a temperature of the stored and captured carbon dioxide rich air and a temperature of the stored and captured oxygen rich air remains substantially the same temperature as when it was captured without conditioning or cooling, and wherein the first and second compartments are installed outside of, and adjoining, the greenhouse.

12. The environment-controlled, multi span structured greenhouse of claim 4, wherein the release blower together with the heating module clears fog created during cold early morning hours from interior surfaces of the roof and the sides by releasing hot air into the greenhouse.

13. The environment-controlled, multi span structured greenhouse of claim 1, wherein the inlet pipe and the outlet pipe of the first compartment and the second compartment are polyvinyl chloride (PVC).

14. The environment-controlled, multi span structured greenhouse of claim 1, wherein the first concrete pipe and the second concrete pipe each include opposing air-tight blocked ends, and the inlet pipe and the outlet pipe are located near the blocked ends.

15. The environment-controlled, multi span structured greenhouse of claim 14, wherein the inlet pipes are located near a first blocked end and the outlet pipes are located near an opposing second blocked end of the first concrete pipe and the second concrete pipe.
